(19) United States
(12) Patent Application Publication
(10) Pub. No.: US 2023/0241948 A1
(43) Pub. Date: Aug. 3, 2023

(54) Vehicle Windshield Melting Device

(71) Applicant: Brian Turner, London (CA)

(72) Inventor: Brian Turner, London (CA)

(21) Appl. No.: 17/734,142

(22) Filed: May 2, 2022

Related U.S. Application Data
(60) Provisional application No. 63/304,735, filed on Jan. 31, 2022.

(51) Int. Cl. B60J 1/00; H05B 3/84; H05B 3/36; B60S 3/04

(52) U.S. Cl. CPC B60J 1/002; H05B 3/84; H05B 3/36; B60S 3/04

(57) ABSTRACT

The present invention relates to a vehicle windshield melting device primarily comprised of a housing, at least one LED, at least one button, a USB port, at least one handle, at least one strap attached to at least one clip, and a screen further comprised of at least one internal heating coil. The device can be placed on the windshield of a vehicle wherein the screen is then deployed from the housing. Then, the heating coil within the screen can be activated using the button to melt snow and ice off the windshield. The clip may be used to further secure the device to the vehicle and prevent movement of the device during use. The device may have a plurality of heating levels for the heating coil, wherein each level can be selected by the button and indicated by the LED. When not in use, the screen can be retracted into the housing.

### CROSS-REFERENCE TO RELATED APPLICATION

The present application claims priority to, and the benefit of, U.S. Provisional Application No. 63/304,735 which was filed on Jan. 31, 2022, and is incorporated herein by reference in its entirety.

### FIELD OF THE INVENTION

The present invention relates generally to the field of melting or defrosting devices. More specifically, the present invention relates to a vehicle windshield melting device primarily comprised of a housing, at least one LED, at least one button, a USB port, at least one handle, at least one strap attached to at least one clip, and a screen further comprised of at least one internal heating coil. The device can be placed on the windshield of a vehicle wherein the screen is then deployed from the housing. Then, the heating coil within the screen can be activated using the button to melt snow and ice off the windshield. The clip may be used to further secure the device to the vehicle and prevent movement of the device during use. The device may have a plurality of heating levels for the heating coil, wherein each level can be selected by the button and indicated by the LED. When not in use, the screen can be retracted into the housing. Accordingly, the present disclosure makes specific reference thereto. Nonetheless, it is to be appreciated that aspects of the present invention are also equally applicable to other like applications, devices and methods of manufacture.

### BACKGROUND

Many individuals living in areas with winter climates do not have access to a garage to store their vehicle. As a result, snow and ice often accumulate on the vehicle as the vehicle sits outside. This is undesirable, as the snow and ice must then be cleaned off the vehicle in order for the vehicle to be used. If the snow and ice buildup is severe, a user may have to spend a significant amount of time outside the vehicle in the cold climate in order to clean snow and ice off the vehicle, and more specifically the vehicle windshield. This process may take too long of a period of time which can then make an individual late to an appointment, meeting, or job.

Therefore, there exists a long-felt need in the art for a device that allows a user to more easily clean snow and ice from their vehicle. There also exists a long-felt need in the art for a vehicle windshield melting device that can be applied to the windshield of a vehicle such that snow and ice are removed from the vehicle windshield. Further, there exists a long-felt need in the art for a vehicle windshield melting device that can be applied to the windshield of a vehicle such that snow and ice are removed from the vehicle windshield and wherein the removal process is quicker than that of existing means of snow and ice removal that involve using a snowbrush and/or ice brush.

The subject matter disclosed and claimed herein, in one embodiment thereof, comprises a vehicle windshield melting device. The device is primarily comprised of a housing, at least one LED, at least one button, a USB port, at least one handle, at least one strap attached to at least one clip, and a screen further comprised of at least one internal heating coil. The device can be placed on the windshield of a vehicle wherein the screen is then deployed from the housing. Then, the heating coil within the screen can be activated using the button to melt snow and ice off the windshield. The clip may be used to further secure the device to the vehicle and prevent movement of the device during use. The device may have a plurality of heating levels for the heating coil, wherein each level can be selected by the button and indicated by the LED. When not in use, the screen can be retracted into the housing.

In this manner, the vehicle windshield melting device of the present invention accomplishes all of the forgoing objectives and provides a device that allows a user to more easily clean snow and ice from their vehicle. The heating process of the device is quicker than that of traditional means of using a snowbrush and/or ice brush and does not require a user to remain standing outside the vehicle while the device is powered on. In addition, the heating process of the device melts ice faster than traditional methods of scraping ice from a windshield.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle windshield melting device. The device is primarily comprised of a housing, at least one LED, at least one button, a USB port, at least one handle, at least one strap attached to at least one clip, and a screen further comprised of at least one internal heating coil. The device and all components are preferably manufactured from a rigid plastic material that is waterproof and UV-resistant or from a durable metal such as, but not limited to, stainless steel or aluminum, unless specified. The housing is preferably generally cylindrical in shape such that at least one screen can be stored within the housing in a rolled fashion. The housing may also have at least one handle that allows the housing to be easily carried when not in use. The housing is further comprised of at least button that allows a user to power the device on/off and also allows a user to select at least one heating level of the screen. The outer surface is further comprised of at least one LED with at least one labeling indicia that indicates the heat level of the device that each LED corresponds to. In the preferred embodiment the device has at least one, but preferably three, heating levels which include low-heat, medium-heat, and high-heat.

The housing also stores at least one battery that may be recharged by at least one USB port located on the housing. The battery is in electrical communication with and supplies power to at least one heating coil that is located within the screen. The device is preferably placed on a vehicle windshield with the screen pulled out from the housing. In this manner, the device can be powered on to the desired heating level such that the coil can melt any snow or ice on the windshield through the screen.

In one embodiment, the device is further comprised of at least one strap that attaches to the housing and/or screen, wherein the strap is further comprised of at least one fastener that allows the strap to become shorter or longer in length. The strap may have at least one clip that can be secured to various portions of a vehicle. The clip may further be comprised of at least one fastener such as, but not limited to, a suction cup that allows the clip to be retained on the vehicle surface. The housing may further have its own at least one fastener of the same type as the fastener of the clip to retain the housing on the vehicle surface.

Accordingly, the vehicle windshield melting device of the present invention is particularly advantageous as it provides a device that allows a user to more easily clean snow and ice from their vehicle using a heating process that is quicker than that of traditional means of using a snowbrush and/or ice brush. Also, the device does not require a user to remain standing outside the vehicle while the device is powered on. Furthermore, the heating process of the device more specifically melts ice faster than traditional methods of scraping ice from a windshield. As a result, the vehicle windshield melting device overcomes the limitations of existing methods and tools used to remove snow and ice from a vehicle windshield known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar referenced characters refer to similar parts throughout the different views, and in which:

FIG. 1 illustrates a perspective view of one potential embodiment of a vehicle windshield melting device of the present invention in accordance with the disclosed architecture;

FIG. 2 illustrates an enhanced perspective view of one potential embodiment of a vehicle windshield melting device of the present invention in accordance with the disclosed architecture;

FIG. 3 illustrates a perspective view of one potential embodiment of a vehicle windshield melting device of the present invention in accordance with the disclosed architecture;

FIG. 4 illustrates an enhanced perspective view of one potential embodiment of a vehicle windshield melting device of the present invention in accordance with the disclosed architecture; and

FIG. 5 illustrates a perspective view of one potential embodiment of a vehicle windshield melting device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that allows a user to more easily clean snow and ice from their vehicle. There also exists a long-felt need in the art for a vehicle windshield melting device that can be applied to the windshield of a vehicle such that snow and ice are removed from the vehicle windshield. Further, there exists a long-felt need in the art for a vehicle windshield melting device that can be applied to the windshield of a vehicle such that snow and ice are removed from the vehicle windshield and wherein the removal process is quicker than that of existing means of snow and ice removal that involve using a snowbrush and/or ice brush.

The present invention, in one exemplary embodiment, is comprised of a vehicle windshield melting device primarily comprised of a housing, at least one LED, at least one button, a USB port, at least one handle, at least one strap attached to at least one clip, and a screen further comprised of at least one internal heating coil. While in use, the device can be placed on the windshield of a vehicle wherein the screen is then deployed from the housing. Then, the heating coil within the screen can be activated using the button to melt snow and ice off the windshield. The clip may be used to further secure the device to the vehicle and prevent movement of the device during use. The device may have a plurality of heating levels for the heating coil, wherein each level can be selected by the button and indicated by the LED. When not in use, the screen can be retracted into the housing.

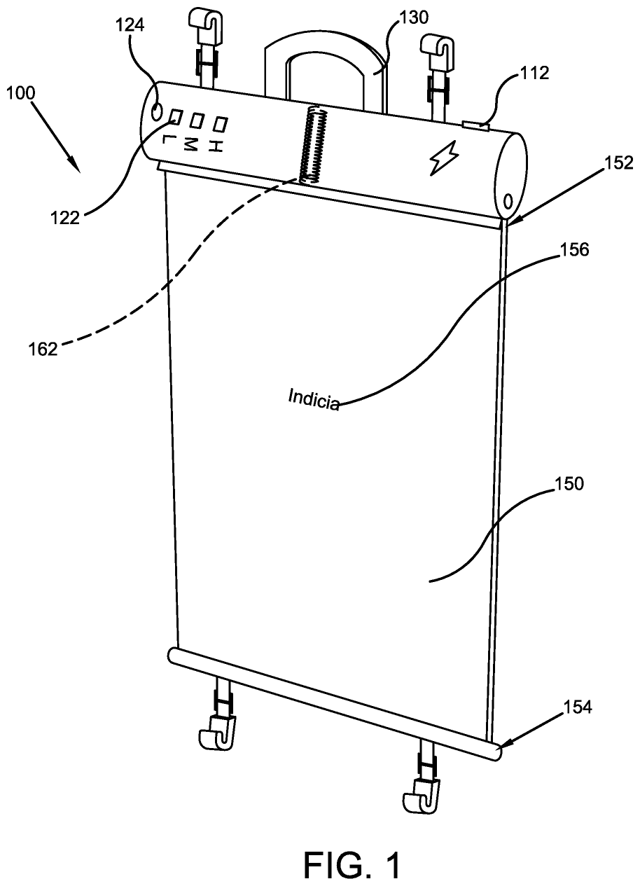

Referring initially to the drawings, FIG. 1 illustrates a perspective view of one potential embodiment of a vehicle windshield melting device 100 of the present invention in accordance with the disclosed architecture. The device 100 is primarily comprised of a housing 110, at least one LED 122, at least one button 124, a USB port 128, at least one handle 130, at least one strap 140 attached to at least one clip 144, and at least one screen 150 further comprised of at least one internal heating coil 158. In the preferred embodiment, the device 100 and all components are manufactured from a rigid plastic such as, but not limited to: acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, recycled plastic, biodegradable plastic, etc. unless otherwise specified. Said plastic material may further be waterproof and UV-resistant. In a differing embodiment, the device 100 and all components are manufactured from a durable metal such as, but not limited to, stainless steel or aluminum, unless specified.

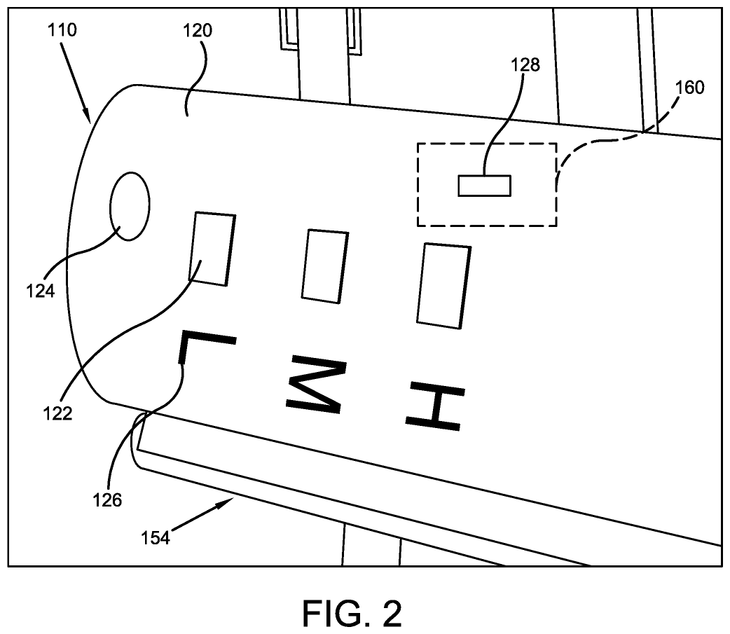

In the preferred embodiment, the housing 110 is generally cylindrical in shape such that at least one screen 150 can be stored within the housing 110 in a rolled fashion. When the device 100 is in use, the screen 150 can be pulled from the housing 110, as will be explained more fully below. The housing 110 may also have at least one handle 130 that allows the housing 110 to be easily carried when not in use. As best seen in FIG. 2, the housing 150 is further comprised of at least button 124 on the outer surface 120 of the housing 150 that allows a user to power the device 100 on/off. The button 124 also allows a user to select at least one heating level of the screen 150. The outer surface 120 is further comprised of at least one LED 122 with at least one labeling indicia 126 that indicates the heat level of the device 100 that each LED 122 corresponds to. In the preferred embodiment the device 100 has at least one, but preferably three, heating levels which include low-heat, medium-heat, and high-heat. Said heating levels each have a corresponding LED 122 that illuminates when each level is active and at least one corresponding indicia 126, such as a word, number, symbol, letter, emblem, logo, etc., that identifies each LED 122 as being representative of each heating level.

The housing 110 also stores at least one battery 160. The battery 160 may be a disposable battery 160 or a rechargeable battery 160 in the form of an alkaline, nickel-cadmium, nickel-metal hydride battery 160, etc., such as any 3V-12 volts DC battery 160 or other conventional battery 160, such as A, AA, AAA, etc., that supplies power to the device 100. Throughout this specification the terms “battery” and “batteries” may be used interchangeably to refer to one or more wet or dry cells or batteries 160 of cells in which chemical energy is converted into electricity and used as a source of DC power. References to recharging or replacing batteries 160 may refer to recharging or replacing individual cells, individual batteries 160 of cells, or a package of multiple battery cells as is appropriate for any given battery 160 technology that may be used. Additionally, the battery 160 may be recharged by at least one USB port 128 located on the housing 110 that may be a USB-A, USB-B, Micro-B, Micro-USB, Mini-USB, or USB-C port.

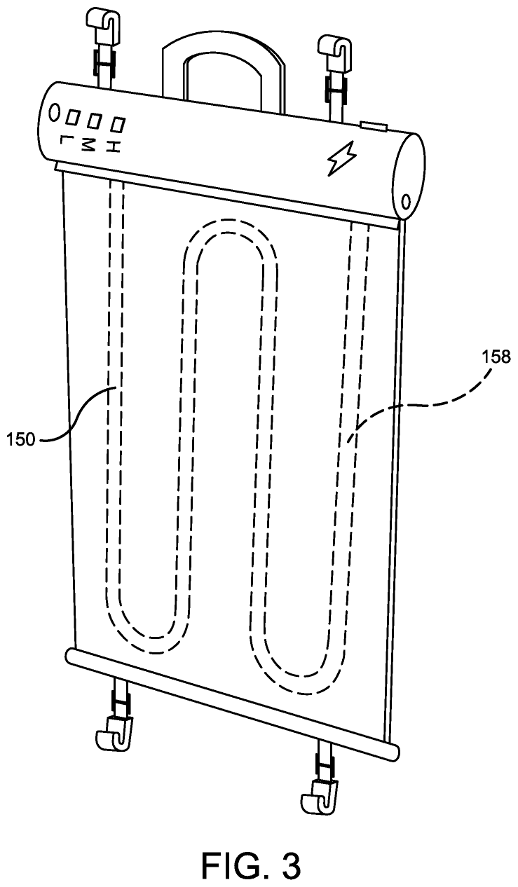

FIG. 3 illustrates a perspective view of one potential embodiment of a vehicle windshield melting device 100 of the present invention in accordance with the disclosed architecture. The battery 160 is in electrical communication with and supplies power to at least one heating coil 158 that is located within the screen 150. The coil 158 may be any electrical wiring, tubing, or similar structure that can produce and radiate heat (without burning through the screen 150) and transfer said heat onto the surface of a windshield 12. The screen 150 may further be manufactured from any waterproof material that can withstand but also facilitate the transfer of heat from the coil 158 to the windshield 12 of a vehicle 10. The first end 152 of the screen 150 is preferably attached to at least one spring 162 within the housing 110 that allows the screen 150 to be extended from the housing 110 when in use and retracted into the housing 110 when not in use in a spring-loaded manner. The second end 154 of the screen 150 may further be weighted to aid in retaining the position of the screen 150 on a vehicle 10 windshield 12. The screen 150 may also have indicia 156 such as, but not limited to: patterns, logos, emblems, images, symbols, designs, letters, numbers, words, characters, animals, advertisements, brands, etc.

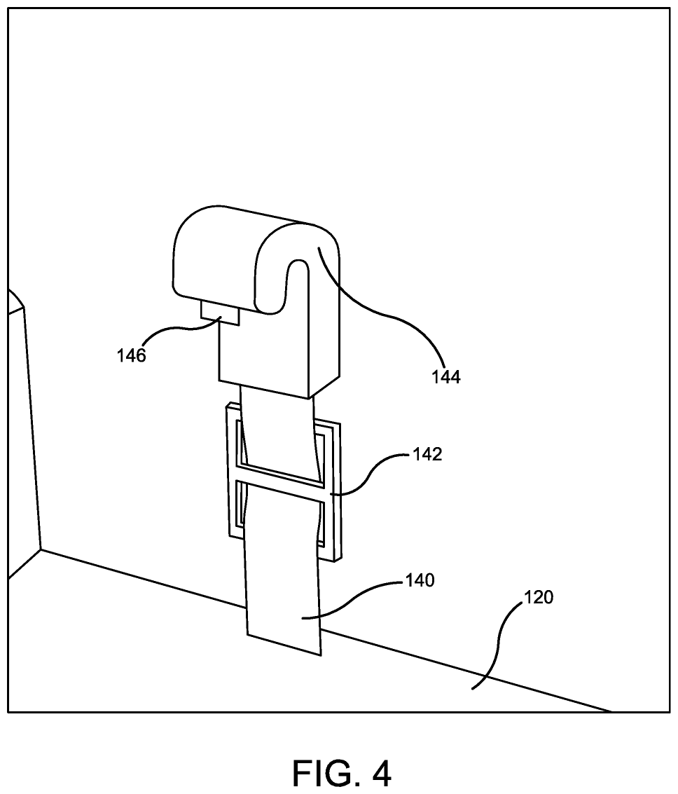

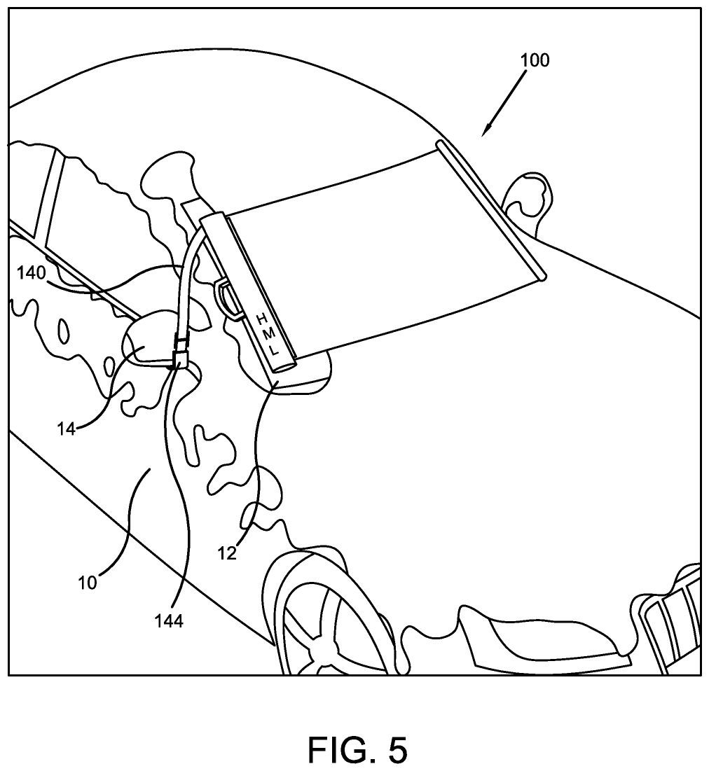

FIG. 5 illustrates a perspective view of one potential embodiment of a vehicle windshield melting device 100 of the present invention in accordance with the disclosed architecture. The device 100 is preferably placed on a vehicle 10 windshield 12 with the screen 150 pulled outwards from the housing 110. In this manner, the device 100 can be powered on to the desired heating level such that the coil 158 of the screen 150 can melt any snow or ice on the windshield 12 through the screen 150. In one embodiment, the device 100 is further comprised of at least one strap 140 that attaches to the housing 110 and/or screen 150. The strap 140 may further have at least one fastener 142 such as, but not limited, buckle, hook, and loop, etc., that allows the strap 140 to become shorter or longer in length. The strap 140 may further be comprised of at least one clip 144 (as best seen in FIG. 4) that can be secured to various portions of a vehicle 10. In one embodiment, the clip 144 is generally J-shaped and can be hooked around the sidemirror 14 of the vehicle 10. The clip 144 may further be comprised of at least one fastener 146 such as, but not limited to a suction cup that allows the clip 144 to be retained on the vehicle 10 surface. The housing 110 may further have its own at least one fastener 112 of the same type as the fastener 146 of the clip 144 to retain the housing 110 on the vehicle 10 surface.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle windshield melting device” and “device” are interchangeable and refer to the vehicle windshield melting device 100 of the present invention.

Notwithstanding the forgoing, the vehicle windshield melting device 100 of the present invention and its various components can be of any suitable size and configuration as is known in the art without affecting the overall concept of the invention, provided that they accomplish the above-stated objectives. One of ordinary skill in the art will appreciate that the size, configuration and material of the vehicle windshield melting device 100 as shown in the FIGS. are for illustrative purposes only, and that many other sizes and shapes of the vehicle windshield melting device 100 are well within the scope of the present disclosure. Although the dimensions of the vehicle windshield melting device 100 are important design parameters for user convenience, the vehicle windshield melting device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle windshield melting device comprising:
a housing;
a screen;
a heating coil;
a battery;
a strap;
a clip attached to the strap;
a button; and
an LED.

2. The vehicle windshield melting device of claim 1, wherein the heating coil is positioned within the screen.

3. The vehicle windshield melting device of claim 2, wherein the screen attaches to the housing.

4. The vehicle windshield melting device of claim 2, wherein battery supplies power to the heating coil.

5. A vehicle windshield melting device comprising:
a housing;
a screen further comprised of a heating coil;
a battery that supplies power to the heating coil;
an adjustable strap;
a clip attached to the adjustable strap;
a button;
a USB port; and
an LED.

6. The vehicle windshield melting device of claim 5, wherein the USB port recharges the battery.

7. The vehicle windshield melting device of claim 5, wherein a second end of the screen is weighted.

8. A vehicle windshield melting device comprising:
a housing;
a screen further comprised of a heating coil, wherein the screen attaches to the housing via a spring;
a handle;
a battery that supplies power to the heating coil;
an adjustable strap;
a clip attached to the strap;
a button; and
an LED.

9. The vehicle windshield melting device of claim 8, wherein the housing is manufactured from a waterproof plastic.

10. The vehicle windshield melting device of claim 9, wherein the waterproof plastic is UV resistant.

11. The vehicle windshield melting device of claim 8, wherein the button turns the vehicle windshield melting device on and off.

12. The vehicle windshield melting device of claim 8, wherein the heating coil is comprised of a low-heat level, a medium-heat level and a high-heat level.

13. The vehicle windshield melting device of claim 12, wherein the button can be used to select a desired one of the low-heat level, the medium-heat level and the high-heat level.

14. The vehicle windshield melting device of claim 12, wherein the LED corresponds to a chosen heating level.

15. The vehicle windshield melting device of claim 8, wherein the strap is comprised of a buckle.

16. The vehicle windshield melting device of claim 8, wherein the clip is J-shaped.

17. The vehicle windshield melting device of claim 16, wherein the clip is further comprised of a suction cup.

18. The vehicle windshield melting device of claim 8, wherein the housing is further comprised of a suction cup.

19. The vehicle windshield melting device of claim 8, wherein the spring is positioned within the housing.

20. The vehicle windshield melting device of claim 8 further comprising a USB port that allows the battery to receive a charge.
